(19) United States
(12) Patent Application Publication
(10) Pub. No.: US 2004/0221507 A1
(43) Pub. Date: Nov. 11, 2004

(54) Method and apparatus for providing hydrogen

(76) Inventors: Benjamin C. Wu, San Ramon, CA (US); Karl Wally, Lafayette, CA (US); Steven F. Rice, Oakland, CA (US); Robert W. Crocker, Fremont, CA (US)

Correspondence Address: Timothy Evans, MS 9031, Sandia National Laboratories, 7011 East Avenue, Livermore, CA, 94550, US

(21) Appl. No.: 10/431,153

(22) Filed: May 7, 2003

(51) Int. Cl. C01B 3/02

(52) U.S. Cl. 48/198.3; 48/198.2; 48/198.7; 48/215; 48/127.9; 48/214 A; 48/214 R

(57) ABSTRACT

Experiments were conducted to investigate the reforming of organic compounds (primarily methanol) in supercritical water at 550° C.-700° C. and 27.6 MPa in a tubular Inconel® 625 reactor. The results show that methanol can be completely converted to a product stream that is low in methane and near the equilibrium composition of hydrogen, carbon monoxide, and carbon dioxide. The effect of reactor temperature, feed concentration of methanol, and residence time on both conversion and product gas composition are presented.

### STATEMENT OF GOVERNMENT INTEREST

This invention was made with Government support under government contract no. DE-AC04-94AL85000 awarded by the U.S. Department of Energy to Sandia Corporation. The Government has certain rights in the invention, including a paid-up license and the right, in limited circumstances, to require the owner of any patent issuing in this invention to license others on reasonable terms.

### TECHNICAL FIELD

This description of embodiments of an invention generally relates to a compact device in which an organic feedstock fuel is hydrothermally converted to produce useful quantities of hydrogen gas in the presence of supercritical water. Also described is a method for efficient hydrogen production wherein the production of carbon monoxide in the hydrogen off-gas is greatly reduced.

### BACKGROUND

The conversion of liquid hydrocarbon fuel into hydrogen and carbon dioxide to feed polymer electrolyte membrane (PEM) fuel cells in a compact and energy efficient unit has numerous potential applications. Several examples of these applications include the replacement of batteries in remote sensors, laptop computers, and automobiles, wherein power demands can range from several milliwatts to 100's of kilowatts. Research groups developing mini- and micro-reforming prototypes are considering a number of approaches. Most approaches have focused on designing miniaturized hydrogen plants that involve a number of individual unit operations (see Pettersson, et al., Int. J. Hydrogen Energy 2001; 26: p.243-264; Joensen, et al., J. Power Sources 2002; 105: p.195-201; de Wild, et al., Catal. Today 2000; 60: p.3-10; and Amphlett, et al., Int. J. Hydrogen Energy 1996; 21: p.673-678). Two examples of known processes for producing an optimized hydrogen stream are: 1) partial oxidation at 800-1100° C. and ambient pressure, or 2) direct catalytic steam reforming over Cu/Zn/Al₂O₃ based catalysts at 250° C. and pressure in the range of 0.1-3.5 MPa. One or more catalytic water-gas shift steps and CO selective oxidation would follow each process to clean up the product stream to suitable purity for PEM fuel cell applications. Experiments on Cu/Zn/Al₂O₃ catalysts have established that the direct steam reforming of methanol in a high steam environment can be rapid, and under certain conditions can lead to a favorable product yield with negligible methane formation (Peppley, et al., Appl. Catal. A 1999; 79: p.21-29; Agrell, et al., J. Power Sources 2002; 106: p.249-257).

There is a substantial body of literature discussing reforming reactions in supercritical water (see for example Savage, Chem. Rev. 1999; 99: p.603-621; or Siskin, et al., J. Anal. Appl. Pyrol. 2000; 54: p.193-214). Of particular note is the work by Antal (Ind. Eng. Chem. Res. 2000; 39: 4040-4053) on dehydration reactions of organic acids and alcohols to more valuable chemicals and gasification reactions of crop-derived carbohydrates for the production of synthesis gas and hydrogen. One investigation by Xu and co-workers (Ind. Eng. Chem. Res. 1996; 35: p.2522. 2530.) showed that methanol reforming (or gasification) in supercritical water resulted in a hydrogen rich product stream that had very low concentrations of both carbon monoxide and methane. They found that the reaction was catalyzed by activated carbon, which resulted in faster conversion of the methanol without sacrificing purity of the hydrogen stream. Watanabe, et al., explored this reaction in the presence of ZrO₂ as a catalyst (Biomass Bioenerg. 2002; 22: p.405-410), while Yu et al., (Energy Fuels 1994, 7: p.574-577) processed glucose, acetic acid, and formic acid at modest concentrations at 600° C. in Inconel® 625 and Hastelloy® C-276. A key observation being that Inconel® 625 appeared to catalyze the water-gas shift reaction and suppress methane formation resulting in a hydrogen rich product stream.

Finally, Li, et al., (U.S. Pat. No. 5,578,647) teach a method for producing an off-gas with a selected CO/H₂ ratio under supercritical water oxidation conditions catalyzed by zeolite® or a cesium-nickel catalyst.

### SUMMARY

An embodiment of an invention is disclosed herein that provides both a device and a method for producing useful quantities of hydrogen gas using a supercritical hydrothermal process. The method comprises the step of contacting an aqueous solution comprising a low weight alcohol at a temperature of at least about 500° C. to about 700° C., preferably about 650° C. to about 700° C., and a pressure above about 27.6 MPa onto a reactor wall surface consisting essentially of a heat resistant nickel-chromium alloy. The device comprises a reformer reactor comprising a tubular helix of a nickel-chromium alloy, a heater and heat exchanger, and semi-permeable membrane, permeable to hydrogen.

It is an object of an embodiment of the device to provide a reactor vessel that avoids processing difficulties caused by depositing a catalyst in sub-mm sized channels by utilizing nickel containing alloy surfaces that act as catalytic reaction sites.

It is an object of an embodiment of the device to provide a means for accommodating very high pressures without the need to resort to thick-wall containment vessels.

It is a further object of an embodiment of the method to provide a preheating step for heating the incoming water/ low weight alcohol solution prior to the step of contacting.

It is another object of an embodiment of the device to provide a heat exchanger comprising a counter-current flow, tube-in-tube arrangement for pre-heating the incoming water/low weight alcohol solution.

It is an object of the above-described device and method, therefore, to use an aqueous solution comprising methanol as the lightweight alcohol, wherein the lightweight alcohol is present in the amounts of between about 15 wt. % and about 45 wt. %.

### BRIEF DESCRIPTION OF THE DRAWINGS

The following drawings form part of the present specification and are included to further demonstrate certain aspects of the present invention and one or more of the specific embodiments presented herein.

FIG. 1 illustrates a schematic of a supercritical water reformer (SCWR) apparatus.

FIG. 2 shows the conversion percentage of methanol versus various feed concentrations of methanol based on total organic carbon in the liquid effluent for two flow-rates.

FIG. 3 shows the mole % composition of dry gas effluent versus feed concentration methanol at flow-rates of 1.2 mL/min and 0.6 mL/min.

FIG. 4 shows the conversion percentage versus reformer furnace temperature based on total organic carbon in the liquid effluent at flow-rates of 1.2 mL/min and 0.6 mL/min.

FIG. 5 shows the mole % composition of dry gas effluent versus reformer furnace temperature at flow-rates of 1.2 mL/min and 0.6 mL/min.

FIG. 6 illustrates the mole % composition of dry gas effluent for experiments using either methanol, ethanol, or ethylene glycol as the fuel, with the SCWR at 700° C., and with an aqueous feed-stock composition of 15 wt. % organic.

FIG. 7 illustrates the reaction pathway diagram for methanol reforming in supercritical water.

FIG. 8 shows a comparison of carbon monoxide and carbon dioxide concentrations in dry gas effluent where methanol is the fuel choice with those predicted by equilibrium calculations versus feed concentration methanol at flow-rates of 1.2 mL/min and 0.6 mL/min.

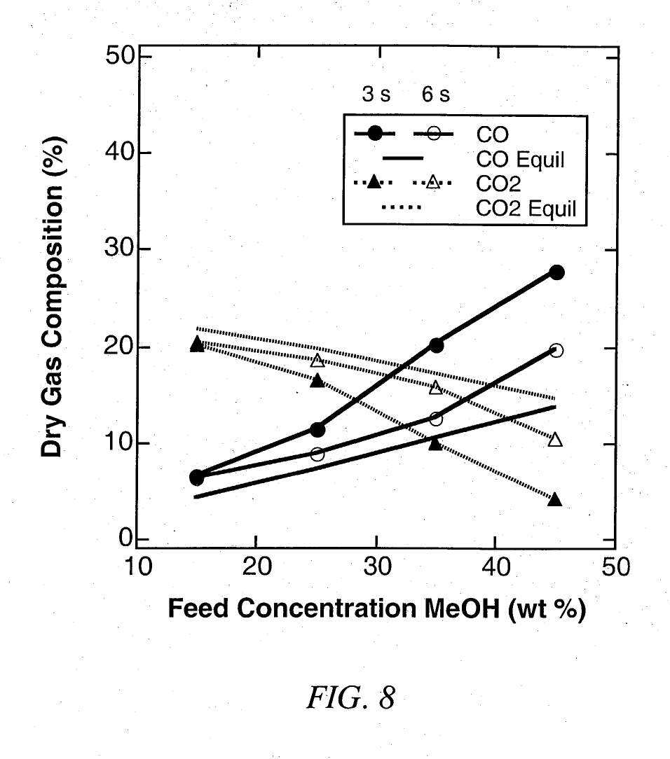

FIG. 9A illustrates the schematic of a practical supercritical water reformer apparatus using internal heat recuperation to pre-heat system reactants wherein the reformed hydrogen is removed after moving through the heat exchanger and cooling.

FIG. 9B illustrates the schematic of a practical supercritical water reformer apparatus using internal heat recuperation to pre-heat system reactants wherein the reformed hydrogen is removed before moving the heat exchanger and therefore remains hot.

FIG. 10 illustrates an idealized operational cycle for a supercritical water reformer.

### DETAILED DESCRIPTION OF THE PREFERRED EMBODIMENTS

The present invention provides a process, operating cycle, and apparatus for converting methanol fuel into hydrogen gas to power hydrogen fuel cells. The process is based on the reforming of methanol fuel into a hydrogen rich gas in a compact supercritical water reformer (SCWR), followed by separation and purification of the hydrogen gas in a membrane-based hydrogen separator. The disclosed apparatus comprises a reactor manifold, a source of heat energy for heating the manifold, a heat exchanger for cooling the reaction products and concurrently heating the feed-stock input stream, a pressure regulation valve for maintaining reactor system pressure above 27.6 MPa and a palladium or polymer membrane separator for purifying the hydrogen that is produced by the reformer process. In addition, the disclosed process is designed to operate at pressures above supercritical pressures for water (22.1 MPa, 3208 psia), and at temperatures above 500° C., and preferably at about 700° C.

A preferred embodiment of the supercritical water reformer system of the present invention, as well as the operating cycle is described below.

### First Embodiment

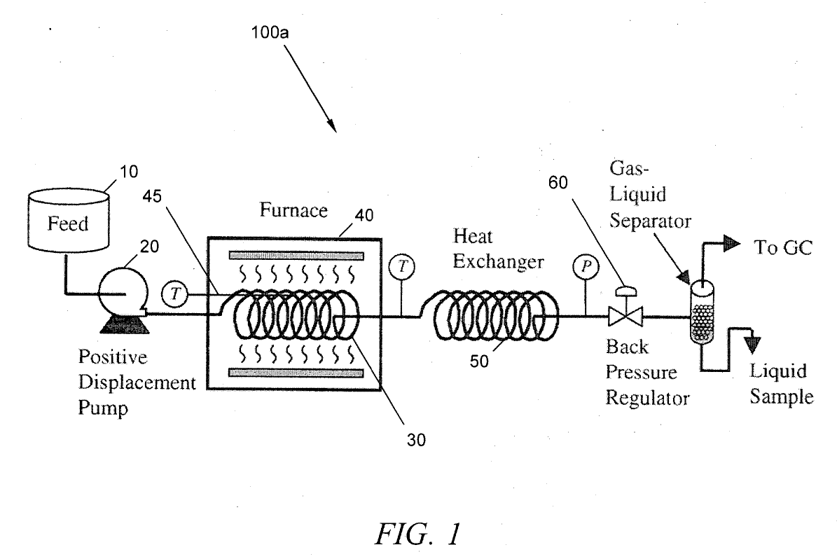

A schematic of the experimental apparatus or reformer system 100a is shown in FIG. 1. System 100a comprises an aqueous organic solution 10 fed by a high-pressure, positive displacement pump 20 capable of providing flow rates of up to at least 10 mL/min into a system reactor 30. The system reactor 30 is itself a coiled 1 meter length of 1.6 mm (1/16″) O.D.×0.25 mm (0.01″) wall Inconel® 625 tubing contained within an 800 Watt tube furnace 40 which is capable of heating reactor 30 to a temperature of between about 500° C. to about 700° C. The practitioner will recognize that while furnace 40 is described as a tube-furnace this feature could be any other form of heating which is capable of raising the temperature of the reactor contents to between about 500° C. to about 700° C.

A sheathed type-K thermocouple 45 placed in the center of furnace 40 provides the temperature measurement for a controller (not shown). Additional temperature measurements are made at 4 axial locations (not shown) along the length of the reactor wall by open junction type-K thermocouples spot welded to the wall. As the fluid exits the reactor, it is rapidly cooled in heat exchanger 50 comprising a second coiled tube.

System pressurization is accomplished by heating the system while outflow from the reformer is prevented or restricted with back pressure regulator 60. Operation may be batch, semi-batch, or continuous mode. In batch mode, a charge of fuel and water are introduced to the system, inlet and outlet valves are closed off, and the fuel/water batch is heated to reforming temperature and pressure. After sufficient dwell time, the outflow is opened to collect products from the system and the cycle may be repeated. In a batch mode, pressure control can be achieved by metering the precise amount of fuel and water charge introduced to the system while limiting the heat input and operating temperature. In a continuous flow system, outlet valve or orifice may operate in a flow restriction mode where the system pressure is limited by the balance between inflow, outflow, and operating temperature to control system pressure. Operating temperature is controlled independently by modulating heat input based on measured reformer temperature. Alternatively, an outlet valve may be cycled between open and closed to control system pressure in a limit cycling mode. In the present embodiment pressure is controlled by inlet and outlet check valves wherein the outlet valve includes a back-pressure regulator valve that is held closed until opened by the predetermined operating pressure. The back-pressure valve utilized in the present embodiment operates at pressures of up to 6000 psig (about 41 MPa).

After pressure letdown, the two-phase effluent enters a gas-liquid separator packed with silica beads, and each stream is analyzed separately.

Gas composition is analyzed via gas chromatography (GC) in an Agilent Technology Micro GC 3000 series containing a 0.5 nm molecular sieve column and a Plot U column in parallel. Both columns are equipped with thermal conductivity detectors that are calibrated with a standard of known composition. Total organic carbon (“TOC”) concentration of the liquid is measured separately in an OI Analytical TOC Analyzer. The maximum measurable TOC value on this analyzer is 10,000 ppm carbon (1% C), so samples were diluted such that their measured TOC values were 0-2000 ppm carbon (0%-0.2% C). Conversion achieved in the reformer was calculated iteratively using the TOC measurements of the feed and product liquid streams and gas composition measurements. Based on the measured gas composition, the global stoichiometry was used to determine the amount of water consumed relative to methanol. With these two measurements, the conversion calculation is straightforward.

### EXAMPLES

Methanol was reformed in SCWR system 100a to produce a stream that was rich in H₂, low in CH₄, and near the equilibrium ratio of CO and CO₂. Aqueous solutions of methanol were prepared at concentrations of 15 wt. %, 25 wt. %, 35 wt. % and 45 wt. % by weight and verified by TOC analysis. These feed-compositions correspond to H₂O:C molar ratios of approximately 10, 5, 3, and 2 respectively and were investigated to determine the effect of methanol concentration on both conversion efficiency and composition of product gas within reactor system 100a at a reaction temperature of about 700° C. In a second set of experiments, a 15 wt. % methanol solution was fed to the reactor with the furnace temperature at 550° C., 600° C., 650° C. and 700° C. to determine the effect of temperature on conversion efficiency and product gas composition. In both sets of experiments, solutions were fed at flow rates of 0.6 mL/min and 1.2 mL/min, which corresponded to nominal residence times of approximately 6 seconds and 3 seconds respectively.

A typical experiment involved initially flowing pure deionized water through the reactor at a flow rate of 1.2 mL/min. System pressure was slowly increased to 27.6 MPa (4000 psig) using the back-pressure regulator. Once the pressure measurement was stable, power was initiated to the tube furnace and temperature increased to the desired set point. The reactor was allowed to equilibrate for approximately 1 hour with deionized water, and the feed was then switched to the aqueous organic solution. After flowing feed solution through the system for at least 30 minutes, a liquid sample was collected (for 10 min of operation) and gas composition was measured with 5 separate gas samples. The feed flow rate was then reduced to 0.6 mL/min and allowed to equilibrate for approximately 1 hour before making measurements.

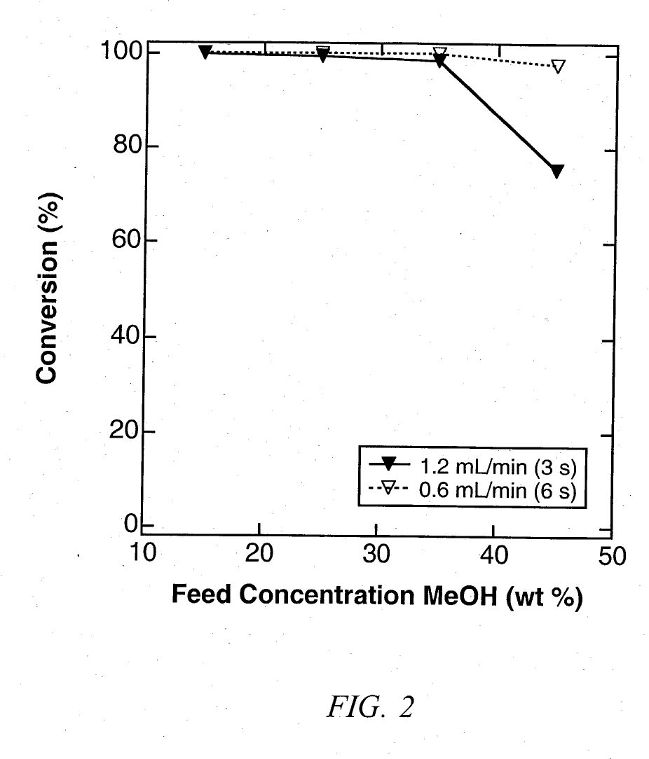

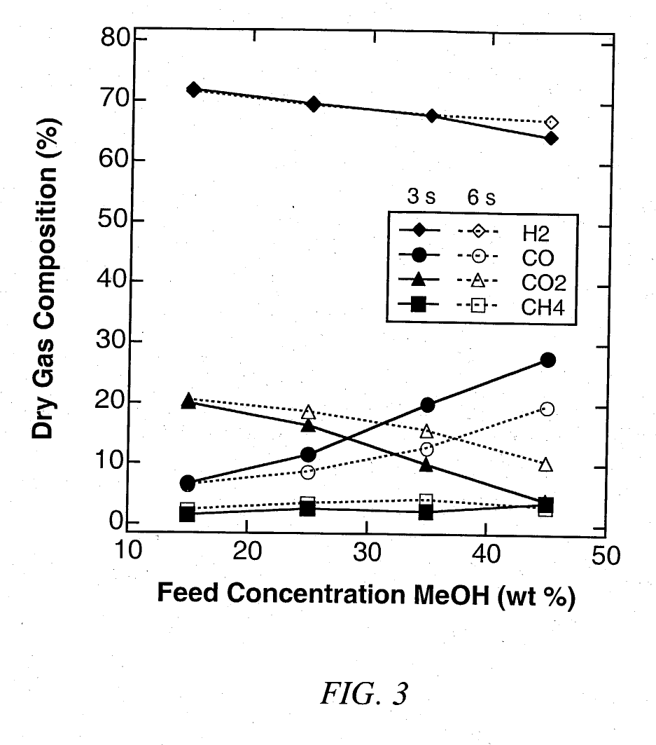

FIG. 2 illustrates the effect of feed-stock concentration on the conversion efficiency of methanol at 700° C. As can be seen, methanol is completely reacted (>99%) for feed concentrations of up to 35 wt. % at the slower feed-stock flow rate of 0.6 mL/min, and for feed concentrations up to about 25 wt. % for the higher flow rate of 1.2 mL/min. The conversion is slightly less (98%-99%) for 35 wt. % methanol at a flow rate of 1.2 mL/min, and incomplete conversion is observed at both flow rates for 45 wt. % methanol feed. The concentration (in mole %) of H₂, CO, CO₂, and CH₄ in the dry product gas is shown in FIG. 3. For both flow rates, CO and CH₄ increase with feed concentration of methanol, whereas H₂ and CO₂ decrease. It is also valuable to compare the two traces for each compound in FIG. 3 to determine the effect of residence time. For a 15 wt. % methanol feed, the composition of the product gas is essentially unchanged with residence time. For all other feed compositions, H₂, CO₂, and CH₄ increase with longer residence time, while CO decreases.

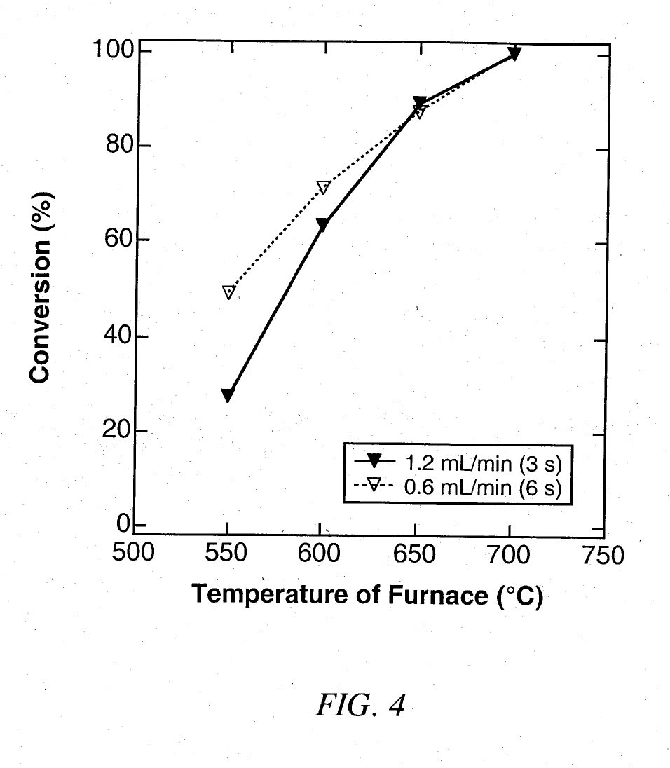

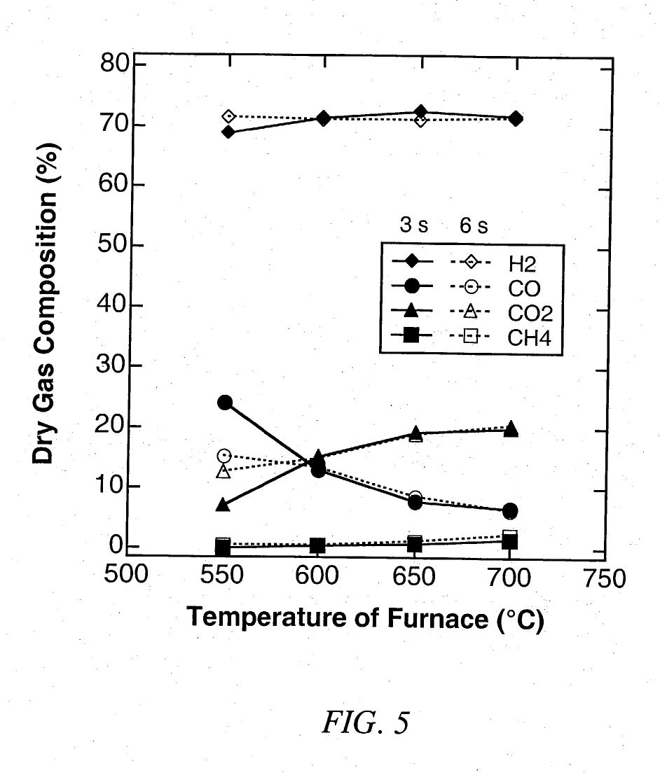

The conversion of methanol (15 wt. % feed) as a function of reactor temperature is shown in FIG. 4. Complete conversion is observed at both flow rates with the reactor at 700° C. The conversion drops steadily as the temperature of the reactor is decreased, reaching only 27% at 550° C. and a nominal residence time of 3 seconds. Plots of the product gas composition as a function of temperature are shown in FIG. 5. In this case, H₂, CO₂, and CH₄ increase while CO decreases with increasing temperature. The composition of the product gas does not change with residence time for 600-700° C. At 550° C., where the CO concentration in the product gas is highest, a significant amount of CO shifts to CO₂ at longer residence time.

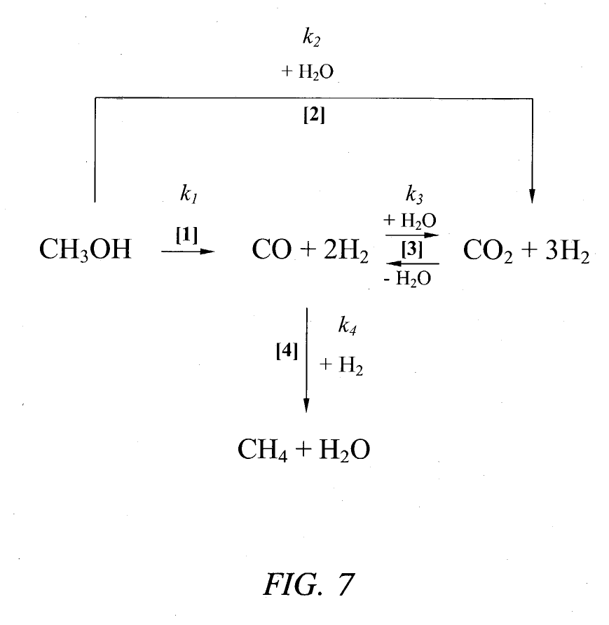

The relevant reaction pathways are illustrated in FIG. 7 and include direct methanol decomposition (reaction [1]), methanol hydrolysis (reaction [2]), water-gas shift (reaction [3]), and CO methanation (reaction [4]). Here, reaction [3] is written as reversible because equilibrium compositions are approached for the water-gas shift reaction. Reactions [1], [2], and [4] are written as forward reaction steps either because equilibrium lies far to the right or because these steps are kinetically rate-limited.

The effect of increasing the feed concentration of methanol on conversion can be seen in FIG. 2. To explain the decrease in conversion of methanol at higher methanol concentrations, it is suggested that active sites on the reactor wall become saturated with adsorbed methanol molecules preventing other molecules from diffusing to the surface and reacting to form products. According to this explanation, therefore, increasing the residence time would allow for more turnover and, correspondingly, more complete conversion. Unfortunately this is not borne out by the observed results (FIG. 4).

Alternatively, the reduced conversion at high feed concentration could result if H₂O molecules enhance the rate of methanol consumption either by catalyzing reaction [1] or if reaction [2] occurs in parallel to reaction [1] (where H₂O would explicitly appear in the rate expression for reaction [2]). Finally, the reduced conversion of methanol at high feed concentration could simply be the result of reduced residence time in the reactor brought on because the feed concentration has more methanol molecules per unit volume and the reaction produces more total product molecules (CO and H₂) near the start of the reactor, effectively expanding the fluid stream. The result of this higher production of gas molecules (more moles/min product) would be to reduce the residence time for any given volume of liquid reactant and causing incomplete conversion of methanol.

The result of higher methanol concentration in the feed on the reformate gas composition is that more CO and less CO₂ are produced (FIG. 3). This unfavorable CO:CO₂ ratio occurs because there is less water present to drive the rate of the forward water-gas shift reaction [3]. Additionally, higher concentrations of CO (and H₂ also, due to less water present) result in higher production of methane. The experimental results in FIG. 3 show that CO is produced at shorter residence times and is subsequently converted to CO₂ (and H₂) at longer residence times. This result is consistent with reactions [1] and [3] being the primary pathways. According to equilibrium calculations, large amounts of methane should be produced; however, these results suggest that the methanation reaction [4] is kinetically limited and yields only small concentrations of methane, a result borne out in FIG. 5 at temperatures below about 650° C.

The conversion of methanol in supercritical water decreases significantly at lower temperatures, as shown in FIG. 5. Since the reaction is assumed to take place on the Inconel® 625 surface and a large temperature dependence is observed, either the adsorption of methanol or the surface reaction must have a significant activation barrier. At lower temperatures, CO is produced at concentrations higher than CO₂. The high concentration of CO observed is likely due to the fact that the water-gas shift reaction is much slower at lower temperatures, indicating a higher activation barrier than the methanol decomposition step.

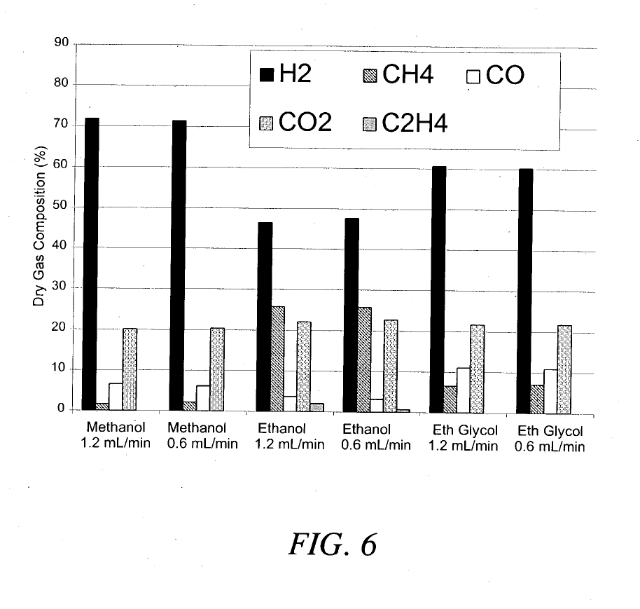

Several other lightweight alcohols were attempted as fuel feedstocks. FIG. 6 illustrates the relative amounts of hydrogen and other reactant by-products produced by the reforming process of the present embodiments. However, with the exception of methanol, each of these fuels was found to foul the reactor to some extent and were therefore set aside as promising feedstock materials.

### Second Embodiment/Internal Heat Recuperation

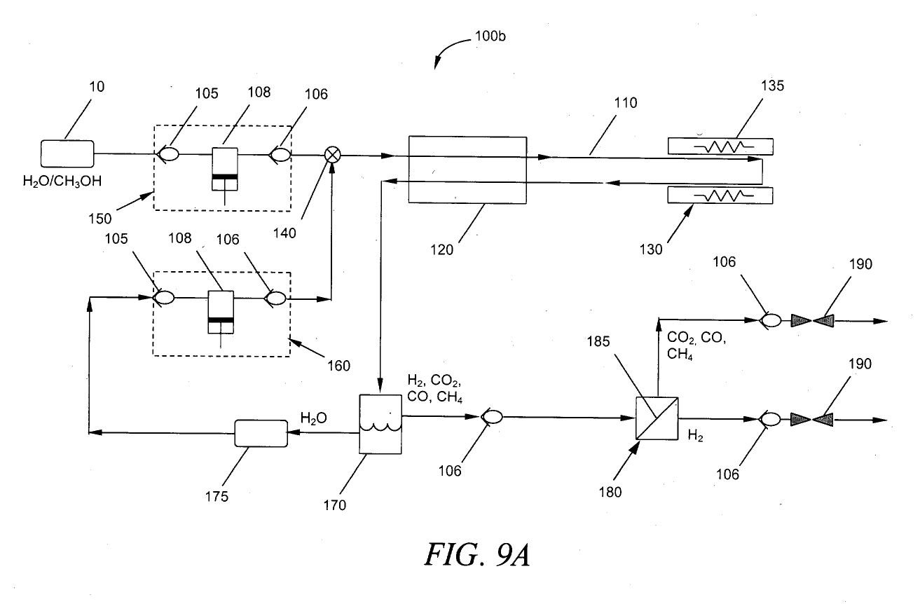

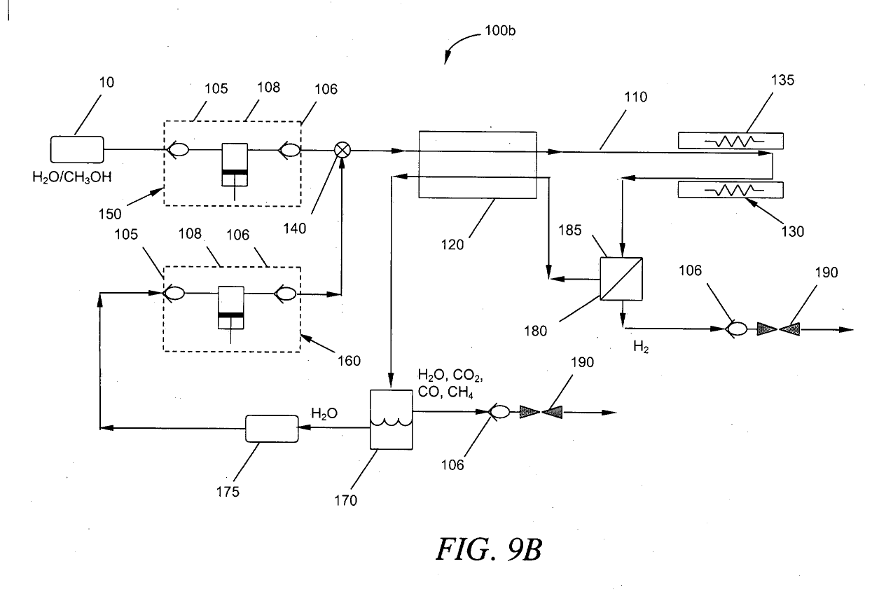

FIGS. 9A and 9B show two embodiments of a system 100b for a practical cycle of 200 Wₑ. At the heart of both embodiments is a long tubular pressurized vessel 110 incorporating a long tube-in-tube counterflow heat exchanger section 120 and a heated reformer section 130, including heater 135. As with embodiment 1, this geometry may be made compact by wrapping it as a cylindrical helix. The resultant reactor package can be made to occupy a volume that is about 3000 cm³ without much difficulty.

As before, system 100b is designed to direct a water/fuel solution from reservoir 10 into first hydraulic pump 150, comprised of inlet check valves 105, piston cylinder 108, and outlet check valve 106. The water/fuel solution enters piston cylinder 108 through check valve 105, where it is pressurized and sent through a second check valve 106 on the outlet side of pump 150 that prevents the solution from back-flowing and effectively maintains operational pressure within system 100b.

The heat of reforming is provided at reformer section 130, and is regulated to maintain the reactor temperature at least at 650° C., and preferably at 700° C. Tubular reactor 110 is maintained under pressure by an outlet pressure regulation valve set to the chosen operating pressure of about at least 27.6 MPa. Hot excess water is recirculated to the vessel inlet 140 by second hydraulic pump 160. A first hydraulic pump 150 pressurizes fuel and water mixture for injection into the recirculated hot water. The fuel and excess water are heated to reactor temperature in the tube-in-tube counterflow heat exchanger section 120 by outflowing reformer fluids, which are cooled to subcritical, hot water temperature in the same process. The outflowing reformer fluids are comprised of a mixture of excess water, hydrogen, carbon dioxide, and some small amounts of carbon monoxide, and methane. Residence time of the liquid reactant materials is adjusted (typically through use of flow orifices and/or similar restriction features in the flow stream) to assure that methanol conversion is essentially complete, and that no unreformed methanol passes through the reactor system.

From the outflowing fluids, hydrogen and other gasses are separated first through a liquid/gas separator 170 and then through gas separation unit 180 comprising hydrogen permeable membrane 185 for removing reactant constituents (principally carbon dioxide and small quantities of carbon monoxide and methane) from the reformed hydrogen gas. Back pressure regulators 190, located after the gas separation unit 180 shown in FIG. 9A and after both the separation units 180 and 170 unit shown in FIG. 9B. This pressure regulator maintains the overall pressure in the system above the 2-phase “dome” of the Mollier diagram and in the supercritical range for the liquid. In the case of liquid/gas separator 170 excess water is redirected to in-line reservoir 175 and then to second hydraulic pump 160. Check valves 105 and 106 prevent water back-flowing through the system.

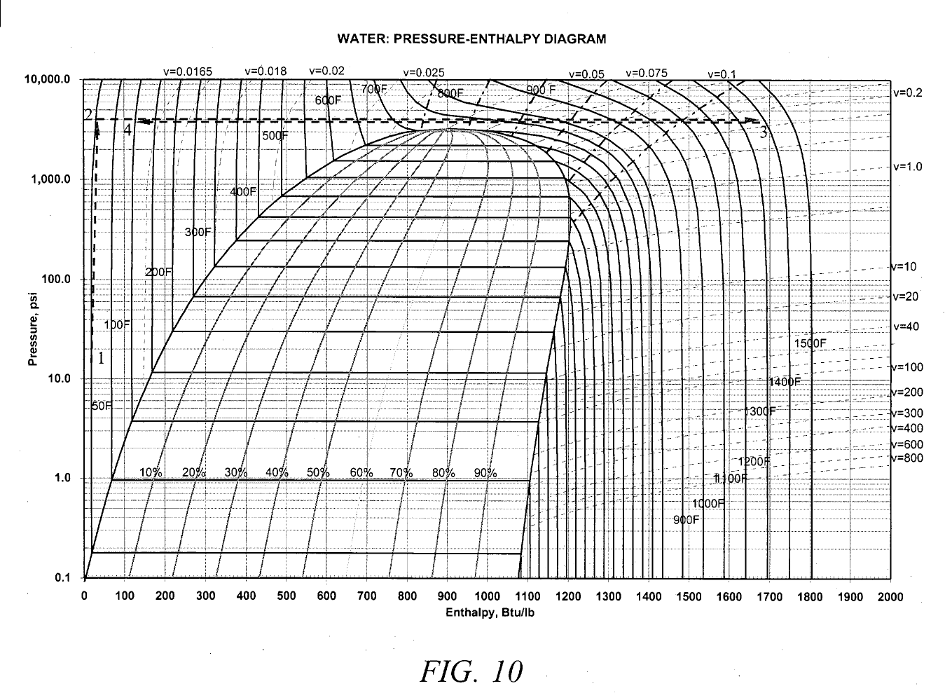

The operating cycle is approximated by the line 1-2-3-4 on the Mollier diagram shown in FIG. 10. The cycle is characterized as an approximation since the diagram is for water only, and any real reforming cycle will employ water-fuel mixture whose constituents and thermodynamic properties vary with time and location in the cycle. Nevertheless, the concept of operation described by this simplified cycle is useful and may be followed with reasonable clarity.

In cycle process 1-2, a water-fuel mixture at ambient temperature and pressure is pressurized by a high pressure pump for injection into a pressure vessel operating at supercritical water pressure, in this case about 4000 psia (27.5 MPa). In cycle process 2-3, the pressurized water-fuel mixture is heated to high temperature at constant pressure until the desired reformer operating temperature is achieved, in this case about 700° C. Additional heat of reformation is gained at process location 3 as the fuel is reformed to hydrogen, carbon dioxide, and other product gases under supercritical water conditions. In cycle process location 3-4, the excess water and product gases are cooled at constant pressure to a temperature at which the excess water is condensed as a pressurized hot liquid. This final step facilitates separation of the product gases from the excess water.

In embodiment 2, the only mechanical work input to the system is the hydraulic feed and recirculation pumps. The hydraulic work of pressurization represents only a small parasitic fraction of the energy flow in the system, which is primarily thermal energy transport in the counterflow heat exchanger and reformer. For a prototype system, high pressure pump heads of the type used in high performance liquid chromatography (HPLC) applications are mated to compact electrical motor drives.

Hydrogen is recovered through a membrane system. The system may either comprise a palladium or a palladium alloy membrane such as for example, Pd—Ag, operating at high temperature because CO is known to poison palladium and palladium alloy membranes at low to moderate temperatures, or a low temperature polymer membrane. A suitable system configuration is shown in FIG. 9B, wherein the gas separator unit is placed directly after the reformer reactor and ahead of the heat exchanger, thus insuring an exiting gas supply at high temperature. The resultant purified hydrogen would be free of contaminating CO and available to fuel a proton exchange membrane hydrogen fuel cell. (Back pressure valve 190 exiting the gas separation unit 180 in this configuration is set at an approximate 1 atmosphere differential to avoid damage to the separator membrane 185. Other configurations are possible of course, including the elimination of valve 190 and instead using an internal support grid to allow separator membrane 185 to withstand the mush larger pressure differential between the reactor and the ambient surroundings.)

Practical engineering considerations suggest the use of the noble metal membrane due to its proven performance and its ability to withstand high pressures which would help to promote the separation process since it is essentially a diffusion process. However, a glassy polymer membrane (e.g. polyimide) is suggested as the best method for recovery of the cooled, low pressure hydrogen gas downstream of the tubular pressure vessel. Polymer membranes of this type have excellent selective permeation for hydrogen, and large hydrogen separators are commercially available for industrial use. These large separators are comprised of myriads of hollow, thread-sized polymeric fibers, so downscaling to the size needed in our application is a simple matter of matching the fiber count to the required permeation area. In this regard, this separation method is also aided by the high pressure at which our outflow gases are available, which increases the permeation flux for a given membrane area.

The heat of reformation may come from one of three possible sources, depending upon several engineering choices. One option is electrical heating using a portion of the gross electrical output of the fuel cell. Despite its inefficiency (due to electric-to-thermal conversion), the convenience, simplicity, and ease of control of this approach make this the most attractive engineering option for very small systems. An alternative source of heat may be from catalytic combustion of a portion of the product hydrogen stream. This is thermodynamically much more efficient than electric heaters, but at the cost of greater complexity and more difficult control of reformer temperature. With already very good reformer efficiency, an only slightly more efficient approach would be to burn a fraction of the methanol fuel directly for reformer heat. This shares similar complexity and reformer temperature control issues with the hydrogen combustion.

What is claimed is:

1. A method of producing hydrogen by a supercritical hydrothermal process, comprising the step of:
contacting an aqueous solution of methanol at a temperature of at least about 650° C. and at a pressure above about 22.1 MPa in the presence of a metal surface comprising a heat-resistant nickel alloy, wherein said nickel alloy comprises at least about 58 wt. % nickel, and at least about 14 wt. % chromium to produce a mixture of off-gases consisting essentially of hydrogen, carbon monoxide, carbon dioxide and methane, wherein said step of contacting further comprises contacting said aqueous solution of methanol in the presence of said metal surface for at least about 10 seconds; and
cooling said off-gases; and
separating said hydrogen from said carbon monoxide, said carbon dioxide and said methane at a glassy polymer interface.

2. The method of claim 1, further comprising the step of preheating the reactant before said step of contacting.

3. The method of claim 2, wherein said step of preheating comprises a heat exchanger.

4. The method of claim 3, wherein said heat exchanger comprises a counter-flow recirculator, wherein said reaction products flow across one or more vessels contained within said recirculator through which said aqueous methanol solution pass, and wherein said reaction products flow in a direction opposite of that of said aqueous methanol solution.

5. The method of claim 1, wherein said glassy polymer interface comprises a plurality of hollow fibers comprising a polyimide.

6. The method of claim 1, wherein said metal surface comprises a long tube having a small inside diameter and a wall thickness equal to at least about one-quarter to one-half said diameter.

7. The method of claim 6, wherein said inside diameter is about 2 mm and said wall thickness is about 1 mm.

8. The method of claim 1, wherein said nickel alloy further comprises molybdenum.

9. The method of claim 1, wherein said nickel alloy comprises a composition of at least 58 wt. % nickel; 20 wt. % to 23 wt. % chromium; 8 wt. % to 10 wt. % molybdenum; and 3 wt. % to 4 wt. % niobium plus tantalum.

10. The method of claim 1, wherein said aqueous solution of methanol comprises methanol in the amounts between about 15 wt. % to about 35 wt. %.

11. The method of claim 1, wherein said pressure is preferably at least 27.6 MPa.

12. A device for providing hydrogen gas, comprising:
a reaction chamber comprising a helically formed metal tube, an inlet and an outlet, and an interior metal surface, wherein said metal tube comprises a metal alloy comprising nickel in an amount of at least about 58 wt. %, and chromium in an amount of at least about 14 wt. %;
means for moving an aqueous methanol solution into said inlet and through said reaction chamber;
means for restricting a flow of reaction products exiting through said outlet;
means for heating said aqueous methanol solution in said reaction chamber to a temperature above about 650° C., said means for restricting adjusted to maintain a pressure of at least about 22.1 MPa in said reaction chamber, wherein said means for restricting and said means for heating operate in combination to initiate and sustain a supercritical hydrothermal reaction between said methanol and said water to produce said reaction products comprising off-gases consisting essentially of hydrogen, carbon monoxide, carbon dioxide and methane;
means for cooling said reaction products; and
a glassy polymer interface means for separating said hydrogen from said carbon monoxide, said carbon dioxide and said methane.

13. The device of claim 12, further comprising means for preheating said aqueous methanol solution.

14. The device of claim 13, wherein said means for preheating comprises a heat exchanger.

15. The device of claim 14, wherein said heat exchanger comprises a counter-flow recirculator, wherein said reaction products flow across one or more vessels contained within said recirculator through which said aqueous methanol solution pass, and wherein said reaction products flow in a direction opposite of that of said aqueous methanol solution.

16. The device of claim 12, wherein said means for restricting a flow of reaction products comprises an inlet check valve and an outlet valve comprising a back pressure regulator valve.

17. The device of claim 12, wherein said metal tube further comprises a small inside diameter and a wall thickness equal to at least about one-quarter to one-half said diameter.

18. The device of claim 17, wherein said inside diameter is about 2 mm and said wall thickness is about 1 mm.

19. The device of claim 12, wherein said metal alloy further comprises molybdenum.

20. The method of claim 12, wherein said nickel alloy comprises a composition of at least 58 wt. % nickel; 20 wt. % to 23 wt. % chromium; 8 wt. % to 10 wt. % molybdenum; 3 wt. % to 4 wt. % niobium and tantalum.

21. The method of claim 12, wherein said aqueous methanol solution comprises methanol in an amount between about 15 wt. % to about 35 wt. %.

22. The method of claim 12, wherein said aqueous methanol solution preferably comprises methanol in an amount between about 15 wt. % to about 25 wt. %.

23. The method of claim 12, wherein said pressures is preferably at least 27.6 MPa.

24. The device of claim 12, wherein said glassy polymer interface means for separating said hydrogen comprises a plurality of hollow fibers comprising a polyimide.
